(19) United States
(12) Patent Application Publication
(10) Pub. No.: US 2026/0355917 A1
(43) Pub. Date: Nov. 12, 2026

(54) YOKE DISPLACING SYSTEMS AND METHODS

(71) Applicant: Tiger Tool International Incorporated, Abbotsford (CA)

(72) Inventors: Michael Andrews, Bellingham, WA (US); Rudolf Maksymilian Klossok, Coquitlam (CA)

(73) Assignee: Tiger Tool International Incorporated, Abbotsford (CA)

(21) Appl. No.: 19/668,657

(22) Filed: May 5, 2026

Related U.S. Application Data
(60) Provisional application No. 63/801,671, filed on May 7, 2025.

(51) Int. Cl. B25B 27/02

(52) U.S. Cl. CPC B25B 27/023

(57) ABSTRACT

A yoke pulling system for displacing a yoke member defining at least one bolt hole from a rod end, the yoke pulling system comprising a pull member, at least one pull plate, at least one transfer member, at least one pull bridge, at least one pull bolt, and a drive system. The at least one pull bolt is arranged to engage the pull bridge and the at least one bolt hole such the at least one transfer member is secured relative to the yoke member. The at least one transfer plate extends between the pull member and the at least one transfer member. Operation of the drive system displaces the pull member to displace the yoke member relative to the rod end such that the pull member is displaced relative to the rod end such that the yoke member is displaced away from the rod end.

### RELATED APPLICATIONS

This application (Attorney’s Ref. No. P220759) claims benefit of U.S. Provisional Application Serial No. 63/801,671 filed May 7, 2025, currently pending.

### TECHNICAL FIELD

The present invention relates to systems and methods of displacing a yoke assembly relative to a rod end.

### BACKGROUND

Yoke assemblies supported on the end of a rod require removal and replacement when worn. Removal of the worn yoke member of a yoke assembly can be difficult because rust and other factors can enhance the bond between the yoke member and the rod end. Yoke pulling systems are thus typically used to apply force on the worn yoke member relative to the rod end.

An example known yoke pulling system employs a pull bar that is secured within a saddle portion of the worn yoke member. The pull bar defines a threaded opening, and a threaded rod is arranged to extend at least partly through the threaded opening such that a tip of the threaded rod engages the rod end. So arranged, axial rotation of the threaded rod applies a driving force that displaces the pull bar, and thus the worn yoke member to which the pull bar is secured, away from the rod end. However, the dimensions of the saddle portion of the yoke member defines the maximum size of the pull bar. In some situations, because of the limitations on the size of the pull bar, the driving force may be sufficient to cause failure of the pull bar. Even when the pull bar does not completely fail, deformation of the pull bar during application of the driving force may damage the threading of the threaded rod and/or the threaded opening defined by the pull bar.

The need thus exists for improved yoke pulling systems that are less susceptible to failure and/or deformation during application of the driving force to displace a yoke member away from a rod end.

### SUMMARY

The present invention may be embodied as A yoke pulling system for displacing a yoke member relative to a rod end, the yoke pulling system comprising: a pull member; at least one pull plate; at least one transfer member; at least one pull bridge; and a drive system. The pull bridge is configured to engage the yoke member such that the at least one transfer member is secured relative to the yoke member. The at least one pull plate extends between the pull member and the at least one transfer member. Operation of the drive system displaces the pull member to displace the yoke member relative to the rod end. Displacement of the pull member relative to the rod end displaces the yoke member away from the rod end through the at least one pull plate, the at least one transfer member, and the at least one pull bridge.

The present invention may be embodied as a method of displacing a yoke member relative to a rod end, the method comprising the following steps. A pull member is provided. At least one pull plate is provided. At least one transfer member is provided. At least one pull bridge is provided. At least one pull bolt is arranged to engage the at least one pull bridge and the yoke member such the at least one transfer member is secured relative to the yoke member. The at least one pull plate is arranged to extend between the pull member and the at least one transfer member. The pull member is displaced relative to the rod end such that the yoke member is displaced away from the rod end through the at least one pull plate, the at least one transfer member, the at least one pull bridge, and the at least one pull bolt.

The present invention may further be embodied as a yoke pulling system for displacing a yoke member defining at least one bolt hole from a rod end. The yoke pulling system comprises a pull member; at least one pull plate; at least one transfer member; at least one pull bridge; at least one pull bolt; and a drive system. The at least one pull bolt is arranged to engage the at least one pull bridge and the at least one bolt hole such the at least one transfer member is secured relative to the yoke member. The at least one pull plate extends between the pull member and the at least one transfer member. Operation of the drive system displaces the pull member to displace the yoke member relative to the rod end. Displacement of the pull member relative to the rod end displaces the yoke member away from the rod end through the at least one pull plate, the at least one transfer member, the at least one pull bridge, and the at least one pull bolt.

### BRIEF DESCRIPTION OF THE DRAWINGS

FIG. 1 is a perspective view illustrating a yoke pulling assembly and example yoke member to be displaced, where the yoke pulling assembly is configured to be used as part of a yoke pulling system to displace the example worn yoke member from a rod end;

FIG. 2 is an exploded, perspective view illustrating components of the yoke pulling assembly in the context of the example worn yoke member to be displaced;

FIG. 3 is a front elevation view illustrating the yoke pulling assembly as attached to the example worn yoke member to be displaced;

FIG. 4 is an end elevation view illustrating the yoke pulling assembly as attached to the example worn yoke member to be displaced;

FIG. 5 is a section view taken along lines 5-5 in FIG. 4;

FIG. 6 is to plan view illustrating the yoke pulling assembly as attached to the example worn yoke member to be displaced;

FIG. 7 is a section view taken along lines 7-7 in FIG. 6;

FIG. 8 is a section view illustrating the example worn yoke member to be removed as attached to an example rod end by an example yoke nut, where the example yoke nut is arranged to secure the example worn yoke member to the example rod end;

FIG. 9 is a section view similar to FIG. 8 but illustrating the example yoke nut removed from the example rod end;

FIG. 10 is a partial section view illustrating the yoke pulling system with the yoke pulling assembly attached to the example worn yoke member, the example worn yoke member attached to the end of the example rod end, and a drive system prior to assembly with the yoke pulling assembly to form the yoke pulling system;

FIG. 11 is a partial section view illustrating the yoke pulling system with the yoke pulling assembly attached to the example worn yoke member, the example worn yoke member attached to the end of the example rod end, and the drive system arranged relative to the yoke pulling assembly to form the yoke pulling system; and

FIG. 12 is a partial section view illustrating the yoke pulling system with the yoke pulling assembly attached to the example worn yoke member, , and the drive system arranged relative to the yoke pulling assembly to form the yoke pulling system, with the drive system having been operated to remove the example worn yoke member from the example rod end.

### DETAILED DESCRIPTION

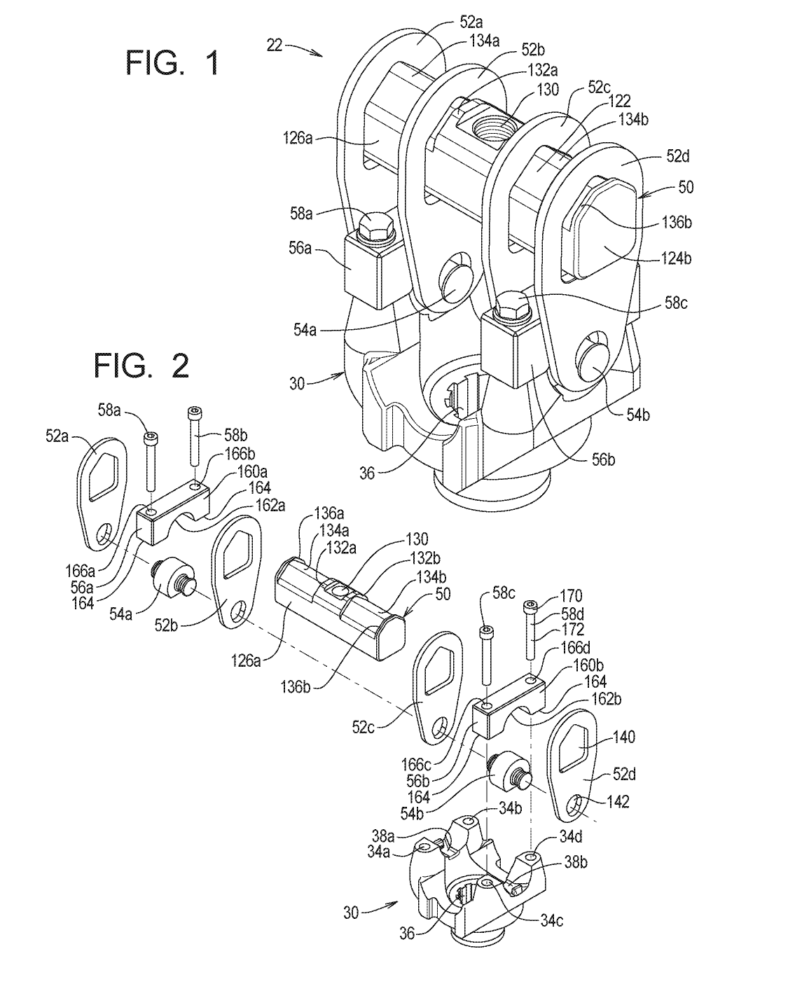

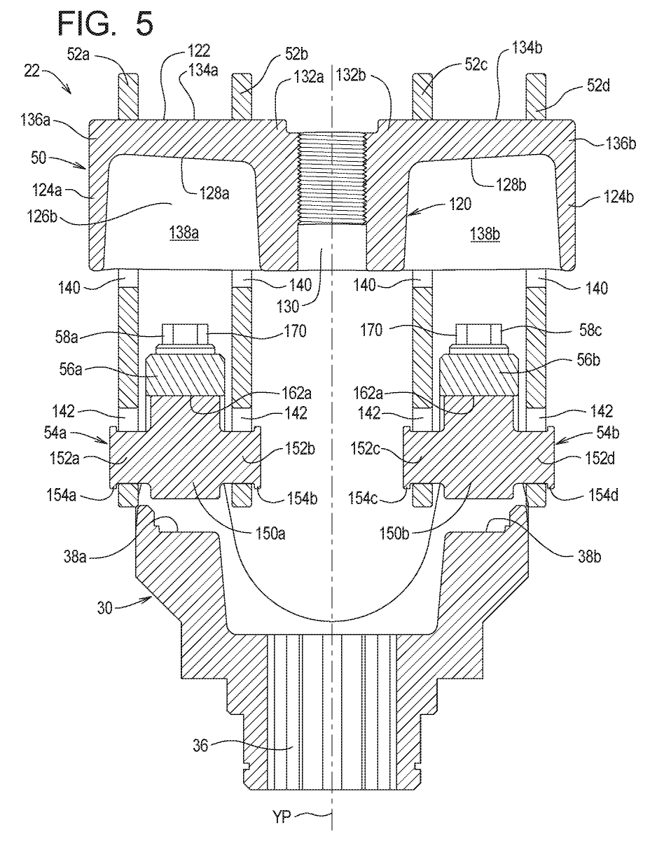

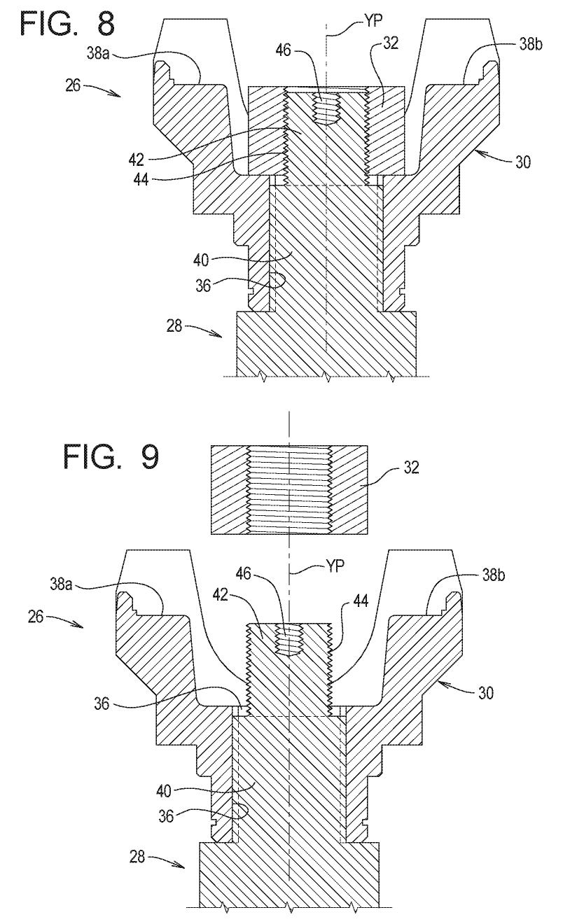

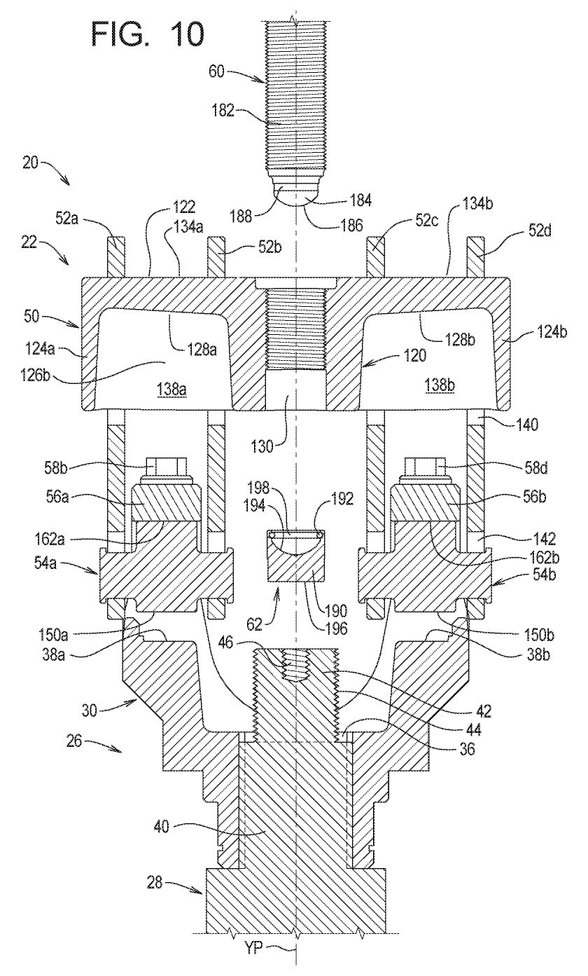

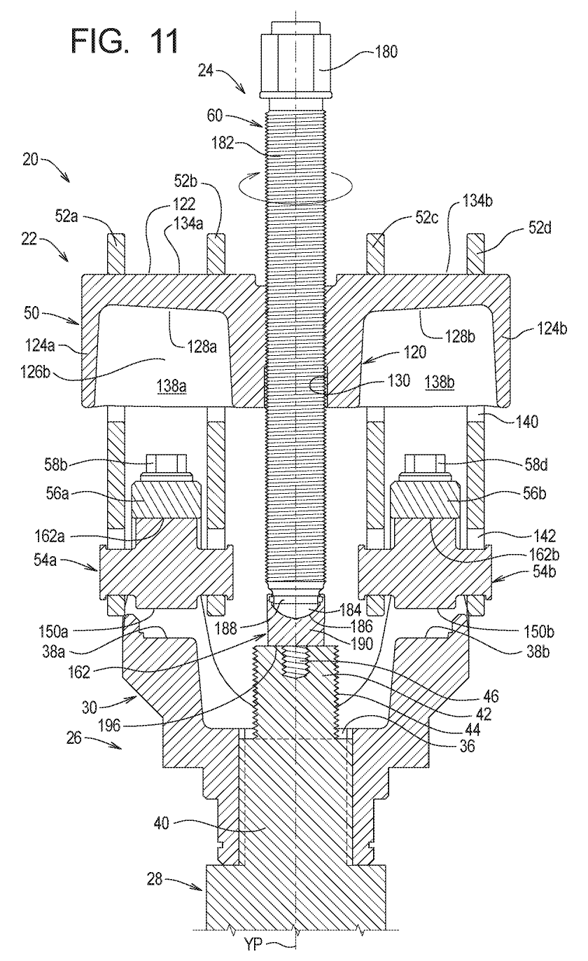

As perhaps best shown in FIG. 11, the present invention is a yoke pulling system 20 comprising a yoke pulling assembly 22 and a drive system 24. The example yoke pulling system 20 is arranged to displace at least a portion of an example yoke assembly 26 relative to an example rod end 28. The example yoke assembly 26 and the example rod end 28 are or may be conventional and will be described herein only to that extent helpful to a complete understanding of the present invention. As perhaps best shown in FIGS. 1, 5 and 7-9, the example yoke assembly 26 comprises an example worn yoke member 30 and an example yoke nut 32. The example worn yoke member 30 defines a plurality of yoke bolt holes 34, a yoke member splined opening 36, and one or more yoke saddle surfaces 38. The example rod end 28 defines a rod end splined portion 40 and a connecting portion 42. The example connecting portion 42 defines an external surface portion 44 and an internal surface portion 46.

The example yoke pulling assembly 22 comprises a pull member 50, at least one pull plate 52, at least one transfer member 54, at least one pull bridge 56, and at least one pull bolt 58. The example drive system 24 comprises a drive bolt 60 and, optionally, a drive bolt cap assembly 62. In use, at least one transfer member 54 is arranged between the worn yoke member 30 and at least one pull bridge 56, and the at least one pull bolt 58 is arranged to secure the at least one pull bridge to the worn yoke member 30. The at least one pull plate 52 is then arranged to extend between the at least one transfer member 54 and the pull member 50. The drive bolt 60 is next arranged to engage both the pull member 50 and the example rod end 28, either directly or indirectly through the optional drive cap assembly 62. With the drive bolt 60 engaging the example pull member 50 and (directly or indirectly) the example rod end 28, operation of the drive system 24 causes displacement of the example worn yoke member 30 away from the example rod end 28.

With the foregoing general understanding of the construction and operation of the example yoke pulling system 20 in mind, the details of construction and operation of the example yoke pulling system 20 will now be described in further detail. In the following discussion, letters appended to numeral reference characters indicate instances of an element or functionally equivalent element and do not suggest different or functionally different elements.

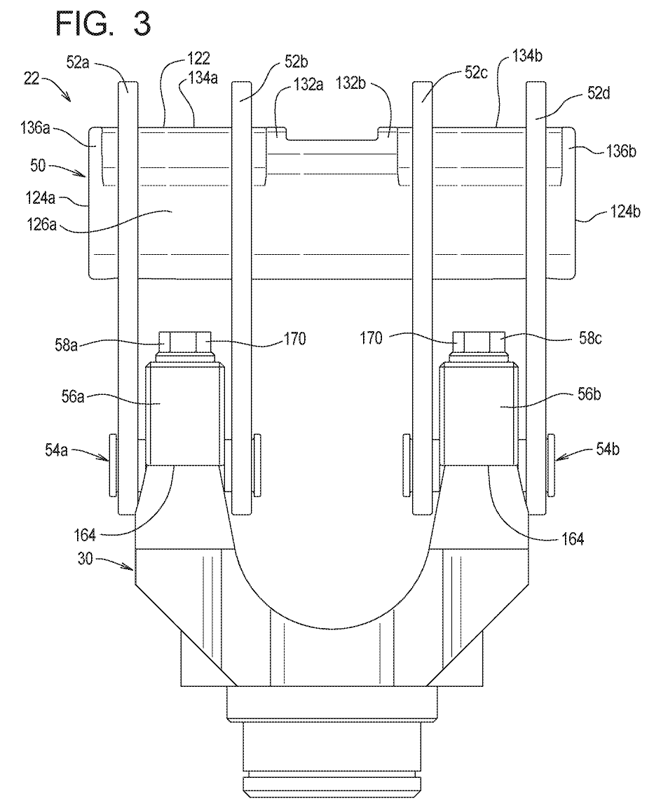

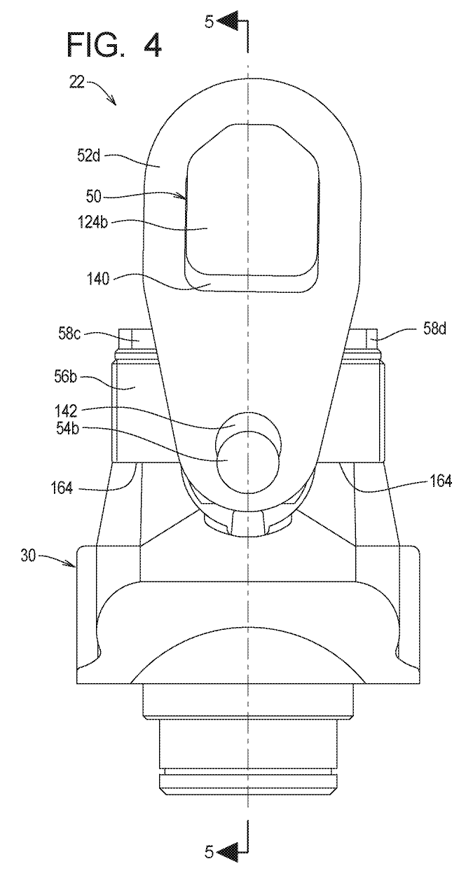

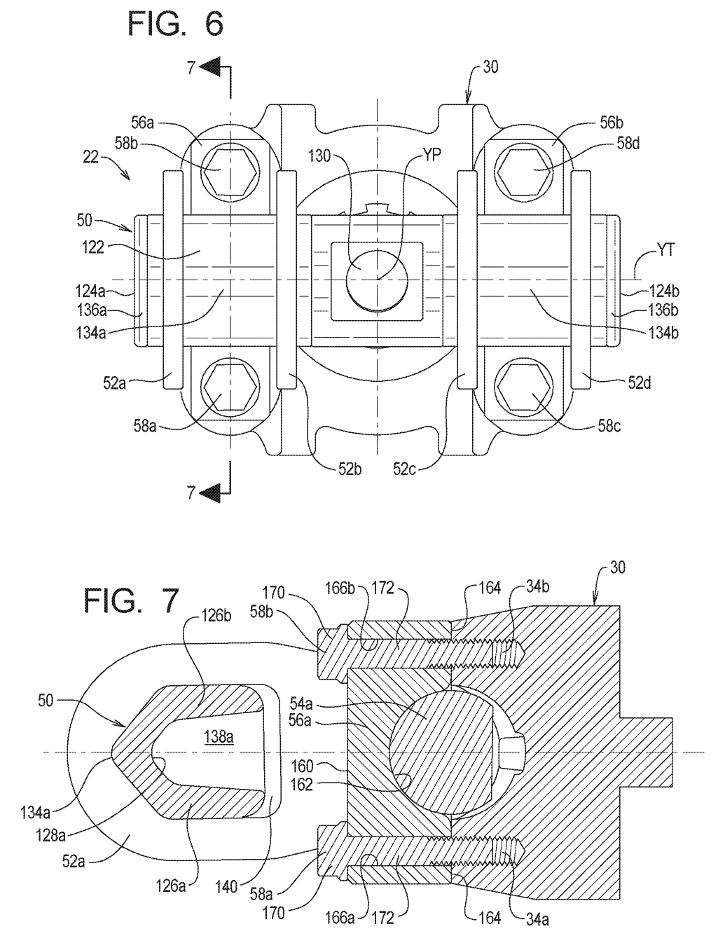

As perhaps best shown in FIGS. 1-7, the example pull member 50 comprises a core portion 120, an upper wall 122, one or more end walls 124, one or more side walls 126, and an inner surface 128. The example core portion 120 defines a drive opening 130 and a central projection 132. The example upper wall 122 defines one or more bearing surfaces 134. An end projection 136 extends from each end wall 124. The upper wall 122, end wall(s) 124, and side wall(s) 126 are optionally configured such that the example inner surface 128 defines at least one inner void 138.

The at least one example pull plate 52 defines a main opening 140 and a transfer opening 142. Each main opening 140 is sized and dimensioned to receive a portion of the example pull member 50. Each transfer opening 142 is sized and dimensioned to receive at least a portion of the at least one transfer member 54.

The at least one example transfer member 54 defines a bridge portion 150 and at least one transfer portion 152. An end flange 154 extends from each transfer portion 152.

The at least one pull bridge 56 defines a pull bolt head engaging surface 160, a transfer member engaging surface 162, at least one yoke engaging surface 164, and at least one bridge bolt opening 166.

The at least one example pull bolt 58 defines a pull bolt head 170 and a pull bolt shaft 172. At least a portion of the pull bolt shaft 172 is threaded.

The example drive bolt 62 comprises a drive bolt head 180, a drive bolt shaft 182, and a drive bolt tip 184. The example drive bolt tip 184 defines a drive bolt drive surface 186 and a drive bolt tip retaining groove 188.

The example drive bolt cap assembly 62 comprises a drive bolt cap 190 and a drive bolt O-ring 192. The example drive bolt cap 190 defines a drive bolt cap inner surface 194 and a drive bolt cap drive surface 196. The example drive bolt cap inner surface 194 defines a drive bolt cap retaining groove 198. The example drive bolt cap retaining groove 198 is sized and dimensioned to partly receive the drive bolt O-ring 192.

As is conventional, the example yoke member 30 defines first, second, third, and fourth yoke bolt holes 34a, 34b, 34c, and 34d and first and second yoke saddle surfaces 38a and 38b. The example yoke splined opening 36 defines a yoke primary axis YP, and first and second example yoke saddle surfaces 38a and 38b define a yoke transverse axis YT, with the yoke transverse axis YT intersecting and orthogonal to the yoke primary axis YP.

When configured to be used with the conventional example yoke member 30, the example yoke pulling assembly 22 comprises a single pull member 50, first, second, third, and fourth pull plate(s) 52a, 52b, 52c, and 52d, first and second transfer members 54a and 54b, first and second pull bridges 56a and 56b, and first, second, third, and fourth pull bolts 58a, 58b, 58c, and 58d. The example pull member 50 defines first and second end walls 124a and 124b, first and second side walls 126a and 126b, and, optionally, first and second inner voids 138a and 138b. The example upper wall 122 defines first and second bearing surfaces 134a and 134b. First and second end projections 136a and 136b extend from the first and second end walls 124a and 124b, respectively. The example upper wall 122, first and second end walls 124a and 124b, and first and second side walls 126a and 126b are configured such that the example inner surface 128 defines first and second inner voids 138a and 138b. The example first transfer member 54a defines a first bridge portion 150a, first and second transfer portions 152a and 152b, and first and second end flanges 154a and 154b. The example second transfer member 54b defines a second bridge portion 150b, third and fourth transfer portions 152c and 152d, and third and fourth end flanges 154c and 154d. The example first pull bridge 56a defines first and second yoke engaging surfaces 164a and 164b and first and second bridge bolt openings 166a and 166b. The example second bridge pull bridge 56b defines third and fourth yoke engaging surfaces 164c and 164d and third and fourth bridge bolt openings 166c and 166d.

To use the example yoke pulling system 20, the example transfer members 54a and 54b are arranged on the first and saddle surfaces 38a and 38b, respectively, defined by the yoke member 30. The first and second pull bridges 56a and 56b are next arranged such that the first, second, third, and fourth bridge bolt openings 166a, 166b, 166c, and 166d are aligned with the first, second, third, and fourth yoke bolt holes 34a, 34b, 34c, and 34d, respectively. The first, second, third, and fourth pull bolts 58a, 58b, 58c, and 58d are then inserted through the first, second, third, and fourth bridge bolt openings 166a, 166b, 166c, and 166d are threaded into the first, second, third, and fourth yoke bolt holes 34a, 34b, 34c, and 34d, respectively. At this point, the example transfer members 54a and 54b are securely held relative to the example yoke member 30 with the first, second, third, and fourth example transfer portions 152a, 152b, 152c, and 152d substantially coaxially aligned with each other and with the yoke transverse axis YT.

Next, the example pull member 50 is arranged such that the first and second bearing surfaces 134a and 134b are substantially equally spaced from the yoke transverse axis YT, with the first and second example transfer portions 152a and 152b spaced a first distance from the first bearing surface 134a and the third and fourth example transfer portions 152c and 152d spaced the first distance from the second bearing surface 134b. Next, the first example pull plate 52a is arranged to engage the first bearing surface 134a and the first transfer portion 152a, the second example pull plate 52b is arranged to engage the first bearing surface 134a and the second transfer portion 152b, the third example pull plate 52c is arranged to engage the second bearing surface 134b and the third transfer portion 152c, and the fourth example pull plate 52d is arranged to engage the second bearing surface 134b and the fourth transfer portion 152d.

As illustrated in FIG. 2, the main openings 140 defined by the pull plates 52a, 52b, 52c, and 52d are sized and dimensioned such that the first and second end projections 136a and 136b can pass through the main openings 140. Similarly, the transfer openings 142 defined by the pull plates 52a, 52b, 52c, and 52d are sized and dimensioned such that the end flanges 154a, 154b, 154c, and 154d can pass through the transfer openings 142. The main openings 140 and end projections 136a and 136b are, however, configured to inhibit inadvertent removal of the end projections 136a and 136b from the main openings 140. Similarly, the transfer openings 142 and end flanges 154a, 154b, 154c, and 154d are configured to inhibit inadvertent removal of the end flanges 154a, 154b, 154c, and 154d from the transfer openings 142.

At this point, the example drive bolt 60 is arranged such that the drive bolt tip 184 passes through the drive opening 130 in the pull member 50. The optional drive bolt cap 190 may then be arranged to engage the drive bolt tip 184 such that the drive bolt drive surface 186 engages the drive bolt cap inner surface 194. The drive bolt O-ring 192 is arranged at least partly within the drive bolt tip retaining groove 188 and the drive bolt cap retaining groove 198 to form a friction and/or interference fit that detachably attaches the drive bolt cap 190 to the drive bolt tip 184.

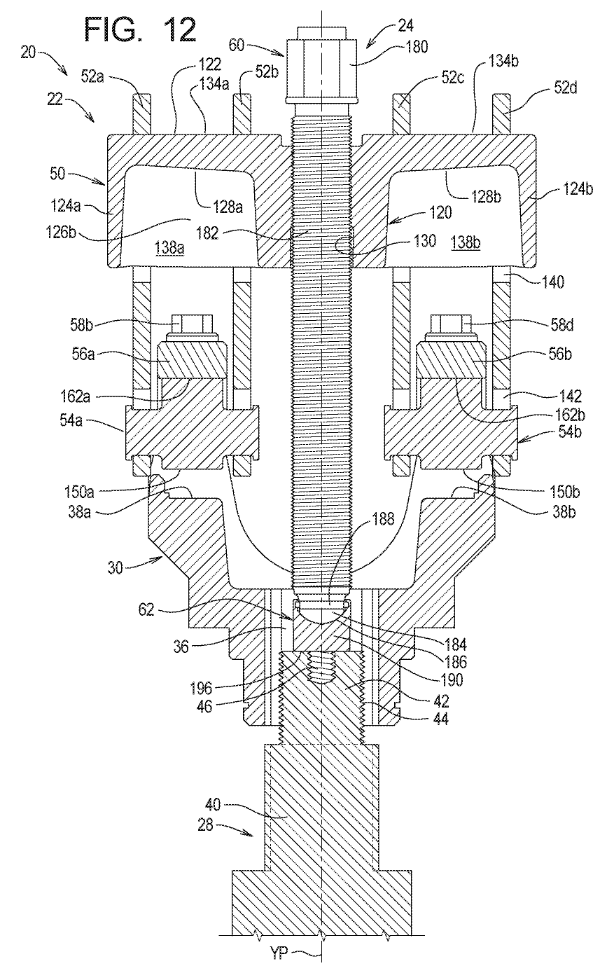

At this point, operation of the drive system 24 causes displacement of the drive bolt 60 relative to the pull member 50 such that the drive bolt cap drive surface 196 engages the connecting portion 42 of the rod end 28 as shown in FIG. 11. Continued operation of the drive system 24 causes further displacement of the drive bolt 60 such that the yoke member 30 is displaced relative to the rod end 28 as shown by a comparison of FIGS. 11 and 12.

In particular, the example drive system 24 is formed by threading engagement of the drive bolt shaft 182 with the drive opening 130 such that axial rotation of the drive bolt 60 relative to the pull member 50 causes displacement of the drive bolt along the yoke primary axis YP. Axial rotation of the drive bolt 60 in a drive direction thus causes the drive bolt tip 184 to move towards the rod end 28 relative to the pull member 50 until the drive bolt drive surface 186 (or the drive bolt cap drive surface 196 if the drive bolt cap 190 is used) comes into contact with the connecting portion 42 of the rod end 28. Axial rotation of the drive bolt 60 can be manual but is preferably accomplished using a conventional hydraulic, pneumatic, or electric drive rotational system (not shown).

Continued axial rotation of the drive bolt 60 in the drive direction causes the pull member 50 to move away from the rod end 28 such that the bearing surfaces 134a and 134b act on the pull plates 52a and 52b and 52c and 52d such that the pull plates 52a, 52b, 52c, and 52d are placed in tension between the pull member 50 and the transfer portions 152a, 152b, 152c, and 152d of the transfer members 54a and 54b. Continued rotation of the drive bolt 60 and corresponding displacement of the pull member 50 thus displaces the transfer members 54a and 54b away from the rod end 28. Displacement of the transfer members 54a and 54b is transferred through the pull bridges 56a and 56b to the yoke member 30 through the pull bolts 58a, 58b, 58c, and 58d such that the yoke member 30 is displaced away from the rod end 28 by axial rotation of the drive bolt 60.

The structure and assembly of the example yoke pulling system 20 is optimized for manufacturing, assembly, and use. However, a pull member 50 of a different configuration may be used. In addition, fewer or more than four pull plates 52 or two transfer members 54, and corresponding pull bridges 56 and pull bolts 58, may be used. Further, drive systems other than a threaded drive bolt 60, such as a hydraulic, pneumatic, or electric linear actuator, may be used as a drive system to displace pull member 50 away from the rod end 28.

What is claimed is:

1. A yoke pulling system for displacing a yoke member relative to a rod end, the yoke pulling system comprising:
a pull member;
at least one pull plate;
at least one transfer member;
at least one pull bridge; and
a drive system; wherein
the pull bridge is configured to engage the yoke member such that the at least one transfer member is secured relative to the yoke member;
the at least one pull plate extends between the pull member and the at least one transfer member;
operation of the drive system displaces the pull member to displace the yoke member relative to the rod end; and
displacement of the pull member relative to the rod end displaces the yoke member away from the rod end through the at least one pull plate, the at least one transfer member, and the at least one pull bridge.

2. The yoke pulling system of claim 1, further comprising at least one pull bolt configured to engage the at least one pull bridge and the yoke member to secure the at least one transfer member relative to the yoke member.

3. The yoke pulling system of claim 1, comprising a pair of pull plates
configured to extend between the pull member and the at least one transfer member.

4. The yoke pulling system of claim 1, comprising
at least one pair of pull plates;
first and second transfer members;
first and second pull bridges; wherein
the first and second transfer members are arranged between the first and second pull bridges; and
the at least one pair of pull plates are configured to extend between the pull member and at least one of the first and second transfer members.

5. The yoke pulling system of claim 1, in which the drive system comprises a drive bolt and a drive cap assembly.

6. The yoke pulling system of claim 1, in which the at least one pull plate defines at least one pull plate opening configured to receive at least one of the pull member and the at least one transfer member.

7. A method of displacing a yoke member relative to a rod end, the method comprising the following steps:
providing a pull member;
providing at least one pull plate;
providing at least one transfer member; and
providing at least one pull bridge;
arranging at least one pull bolt to engage the at least one pull bridge and the yoke member such the at least one transfer member is secured relative to the yoke member;
arranging the at least one pull plate to extend between the pull member and the at least one transfer member; and
displacing the pull member relative to the rod end such that the yoke member is displaced away from the rod end through the at least one pull plate, the at least one transfer member, the at least one pull bridge, and the at least one pull bolt.

8. The method of claim 7, comprising a pair of pull plates
configured to extend between the pull member and the at least one transfer member.

9. The method of claim 7, comprising
at least one pair of pull plates;
first and second transfer members;
first and second pull bridges; wherein
the first and second transfer members are arranged between the first and second pull bridges; and
the at least one pair of pull plates are configured to extend between the pull member and at least one of the first and second transfer members.

10. The method of claim 7, in which the drive system comprises a drive bolt and a drive cap assembly.

11. The method of claim 7, in which the at least one pull plate defines at least one pull plate opening configured to receive at least one of the pull member and the at least one transfer member.

12. A yoke pulling system for displacing a yoke member defining at least one bolt hole from a rod end, the yoke pulling system comprising:
a pull member;
at least one pull plate;
at least one transfer member;
at least one pull bridge;
at least one pull bolt; and
a drive system; wherein
the at least one pull bolt is arranged to engage the at least one pull bridge and the at least one bolt hole such the at least one transfer member is secured relative to the yoke member;
the at least one pull plate extends between the pull member and the at least one transfer member;
operation of the drive system displaces the pull member to displace the yoke member relative to the rod end; and
displacement of the pull member relative to the rod end displaces the yoke member away from the rod end through the at least one pull plate, the at least one transfer member, the at least one pull bridge, and the at least one pull bolt.

13. The yoke pulling system of claim 12, further comprising a drive system configured to displace the pull member.

14. The yoke pulling system of claim 13, in which the drive system comprises a drive bolt and a drive cap assembly.

15. The yoke pulling system of claim 12, comprising a pair of pull plates
configured to extend between the pull member and the at least one transfer member.

16. The yoke pulling system of claim 12, comprising
at least one pair of pull plates;
first and second transfer members;
first and second pull bridges; wherein
the first and second transfer members are arranged between the first and second pull bridges; and
the at least one pair of pull plates are configured to extend between the pull member and at least one of the first and second transfer members.

17. The yoke pulling system of claim 1, in which the at least one pull plate defines at least one pull plate opening configured to receive at least one of the pull member and the at least one transfer member.
